(19) United States
(12) Patent Application Publication
(10) Pub. No.: US 2005/0159540 A1
(43) Pub. Date: Jul. 21, 2005

(54) Fluororesin composition

(76) Inventor: Keigo Goshiki, Saitama-shi (JP)

Correspondence Address: W. L. Gore & Associates, Inc.;551 Paper Mill Road, P.O. Box 9206, Newark, DE, 19714-9206, US

(21) Appl. No.: 10/984,688

(22) Filed: Nov. 9, 2004

(30) Foreign Application Priority Data
Nov. 13, 2003 (JP) 2003-384006

(51) Int. Cl. C08K 3/00

(52) U.S. Cl. 524/544

(57) ABSTRACT

A fluororesin composition comprising a mixture of a fluororesin and carbon nanotubes whose surfaces have been treated with a fluorine-based surfactant is described. The fluororesin composition of the present invention has enhanced conductivity, electrostatic charge properties, and other electrical properties.

### FIELD OF THE INVENTION

The present invention relates to a fluororesin composition, and particularly relates to a fluororesin composition that can be used for a conductive material or other material having excellent surface resistance.

### BACKGROUND OF THE INVENTION

Resin compositions in which a conductive filler is added to a synthetic resin material are used as materials having conductive properties in various applications including materials for electronics.

The use of carbon nanotubes as a conductive filler composed of conventional electroconductive carbon black has been proposed (see Japanese Laid-Open Patent Application No. 2003-192914).

It is known that when carbon nanotubes are added as a conductive filler to a synthetic resin, the same level of conductivity is obtained by adding a ratio of 1/3 to 1/1 thereof compared to a case in which PAN-type carbon fibers are added. The reason for this is considered to be that carbon nanotubes have high conductivity and a high aspect ratio compared to the conventional carbon-type conductive filler, so a network structure is more easily formed in the synthetic resin into which the carbon nanotubes are admixed, the nanotubes are fine and have low bulk density, and the number thereof per unit of weight increases.

When a conductive material containing a carbon conductive filler is used in various types of electronic materials, electronic devices, wire shielding, and the like, there is a possibility that electrical short-circuiting and other serous problems will occur when the conductive filler is shed because of friction and the like.

Carbon nanotubes are smaller than the conventional conductive carbon material, and they have the characteristic of a low occurrence of shedding due to damage, because they almost never “float up” from the resin composition, have excellent surface properties, and are a substance having high strength and elasticity.

Carbon nanotubes are also composed solely of carbon atoms and, unlike carbon black, they contain almost no impurities. The nanotubes are not altered even in response to the exposure to high temperatures during molding or use, there is no possibility of the carbon nanotubes decomposing the synthetic resin into which they are admixed or causing emission of gas from a molded product, and carbon nanotubes can be depended on as a material used for electronic parts.

Admixture of carbon nanotubes as a filler in a fluororesin is also proposed (see Japanese Laid-Open Patent Application No. 2003-192914).

When carbon nanotubes are admixed as a filler in a fluororesin, a fluororesin composition can be provided having both the excellent properties of carbon nanotubes and the chemical stability of the fluororesin.

### DESCRIPTION OF FIGURES

FIG. 1: Table 1 describes properties of the fluororesin compositions illustrative of the present invention.

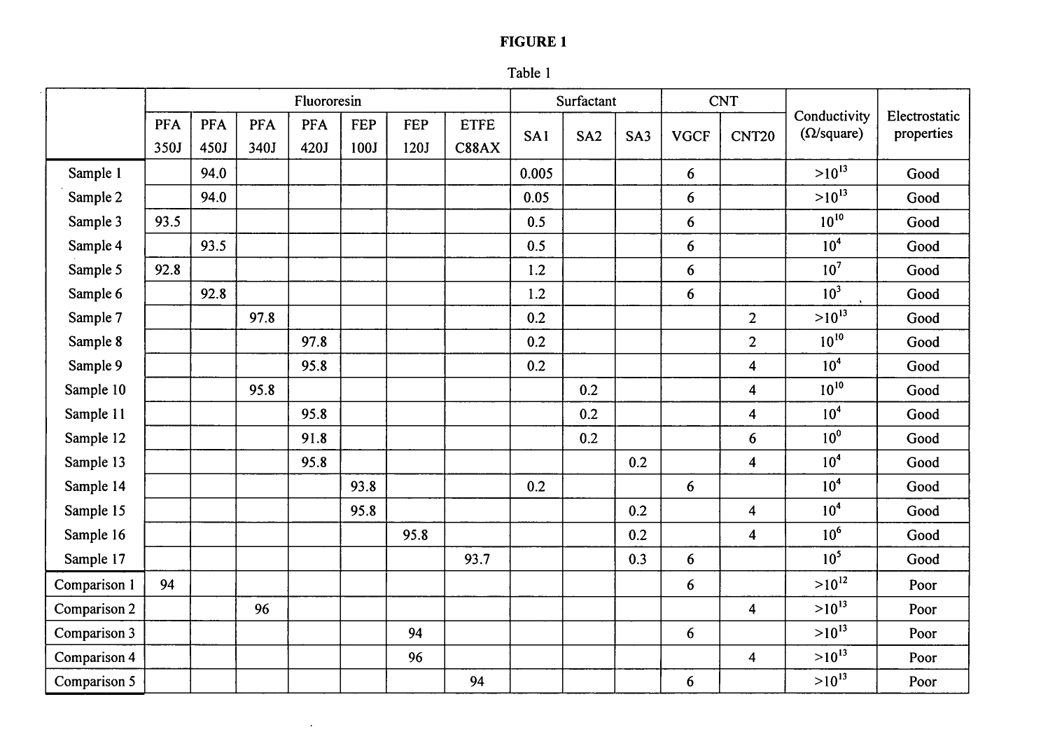

### DETAILED DESCRIPTION OF THE INVENTION

The present invention relates to a fluororesin composition, and an object thereof is to provide a composition in which carbon nanotubes are added as a conductive filler to a fluororesin, wherein the fluororesin composition has good conductivity and electrostatic charge properties.

The object of the present invention can be achieved with a fluororesin composition obtained as a result of mixing a fluororesin and carbon nanotubes whose surfaces have been treated with a fluorine-based surfactant.

The fluorine-based surfactant in the fluororesin composition is also at least one type selected from the group that includes fluoroalkyl sulfonates, fluoroalkyl carbonates, and salts thereof.

The terminal groups of the fluororesin in the fluororesin composition are also stabilized.

The fluororesin with stabilized terminal groups in the fluororesin composition is a substance selected from perfluoroalkoxyalkane polymers and perfluoroethylene propylene copolymers.

In the fluororesin composition of the present invention, carbon nanotubes are mixed with a fluororesin after undergoing surface treatment in advance with the help of a fluorine-based surfactant, so a fluororesin composition can be obtained in which compatibility of the carbon nanotubes with the fluororesin is increased, shedding from the fluororesin is reduced, and conductivity is increased as a result of the enhanced compatibility with the fluororesin.

As a result of admixing the carbon nanotubes as a conductive filler after treating them with a fluorine-based surfactant, the fluororesin composition of the present invention has high conductivity with a smaller quantity of filler admixed therein and is useful as a low-noise electromagnetic shielding material or the like. Furthermore, the resulting fluororesin composition has good electrostatic charge properties, does not shed the carbon nanotubes used as a filler, and possesses low electrostatic charge, so the present invention is extremely useful as a material for various types of electronic parts of which a high degree of reliability is required.

Furthermore, the necessary conductivity is obtained as a result of the admixture of a small quantity of carbon nanotubes, so reduced workability due to admixture of a filler can also be minimized without harming the inherent surface properties or mechanical properties of the fluororesin.

The present invention is a fluororesin composition in which carbon nanotubes are used as a conductive filler. It was discovered that because the carbon nanotubes are treated in advance with a fluorine-based surfactant, a fluororesin composition having a high degree of conductivity, a low occurrence of shedding of the filler, and good workability and mechanical properties can be provided as a result of using a smaller admixed quantity of carbon nanotubes as a result of increased compatibility thereof with the fluororesin.

It was also discovered that the properties of the resultant fluororesin composition change significantly according to the chemical structure of the terminal groups of the fluororesin used, and that the conductivity and electrostatic properties change according to the structure of the terminal groups. It was also discovered that it was possible to provide a fluororesin composition that has excellent conductivity and other properties as a result of using a fluororesin having specific terminal groups.

A fluororesin has excellent chemical resistance and other properties compared to a synthetic resin, and fluororesins are widely used in fields that require chemical resistance, or in fields that require the absence of contamination or other problems brought about as a result of liquids based on eluates from plastics.

In particular, fluoropolymers manufactured as a result of the polymerization of fluoromonomers can be molded into a variety of shapes, and are therefore suited for the manufacture of fluororesin compositions mixed with conductive fillers.

Initiating agents, chain transfer agents, and the like are admixed during polymerization of fluoromonomers, so it has been impossible to prevent the formation of amide groups, carbinol groups, carboxyl groups, and other chemically unstable terminal groups in the polymer thus formed due to the action of the aforementioned chemicals, or due to side reactions.

Such unstable terminal groups can cause problems in some fluororesin applications because of possible reactions, and semiconductor manufacturing and other processes that require high stability are carried out using a fluororesin within which the unstable terminal groups are fluorinated and stabilized with the help of fluorine gas or another fluorinating agent.

When carbon nanotubes treated with a fluorine-based surfactant are used to form a mixture with a fluororesin having stabilized terminal groups, excellent electrical conductivity properties, and especially excellent electrostatic charge properties, are demonstrated in the fluororesin composition of the present invention.

The fluorine-based surfactant used in the fluororesin composition of the present invention may be a fluoroalkyl sulfonate or a salt thereof, or a fluoroalkyl carbonate or a salt thereof, and specific examples thereof include potassium perfluorooctane sulfonate, lithium perfluorooctane sulfonate, potassium perfluorobutane sulfonate, and the like.

Treatment with the help of the fluorine-based surfactant of the present invention may be performed according to a method whereby a fluorine-based surfactant is brought into contact with the carbon nanotubes; for example, treatment may be performed as a result of soaking the carbon nanotubes in an organic solvent solution or aqueous solution of the fluorine-based surfactant and drying the product.

The quantity of the fluorine-based surfactant added is preferably 0.001% by mass or more with respect to the entire quantity of the composition, more preferably 0.003% by mass or more and 5% by mass or less, and even more preferably 0.005% by mass or more and 2% by mass or less. Also, the added quantity does not include the solvent.

Good conductivity is not obtained if this added quantity is less than 0.001% by mass, and workability is reduced if this quantity is more than 5% by mass.

Fluororesins that can be used in the manufacture of the fluororesin composition of the present invention include polytetrafluoroethylene (PTFE), tetrafluoroethylene-fluoroalkyl vinyl ether copolymer (PFA), tetrafluoroethylene-hexafluoropropylene copolymer (FEP), tetrafluoroethylene-ethylene copolymer (ETFE), polyvinylidene fluoride (PVDF), polychlorotrifluoroethylene (PCTFE), ethylene chlorotrifluoroethylene copolymer (ECTFE), and the like.

The fluororesin with stabilized terminal groups is produced with the help of a method in which the terminal groups of a fluororesin obtained as a result of polymerization are fluorinated with a fluorinating agent. Specific examples include at least one type selected from the group that includes tetrafluoroethylene-hexafluoropropylene copolymer (FEP), tetrafluoroethylene-fluoroalkyl vinyl ether copolymer (PFA), tetrafluoroethylene-ethylene copolymer (ETFE), and tetrafluoroethylene-hexafluoropropylene-vinylidene fluoride ternary copolymer (THV).

Fully fluorinated polymers are preferred among these, and tetrafluoroethylene-hexafluoropropylene copolymer (FEP) and tetrafluoroethylene-fluoroalkyl vinyl ether copolymer (PFA) are particularly preferred.

A fluororesin whose terminal groups are not stabilized may also be admixed together with the fluororesin having stabilized terminal groups in the present invention. It is preferred that one-third or more of the entire mass of the fluororesin used be a fluororesin with stabilized terminal groups, and more preferably that one-half or more of the total mass thereof be a fluororesin with stabilized terminal groups, in order to adequately obtain the properties of a fluororesin with stabilized terminal groups.

Carbon nanotubes that can be used in the fluororesin composition of the present invention include single layer carbon nanotubes (SWCNT), multilayer carbon nanotubes (MWCNT), vapor-grown carbon fibers (VGCF), carbon nanofoam, and other carbon nano-porous materials having conductivity.

The carbon nanotubes preferably have a diameter of 1 nm to 300 nm, and the aspect ratio thereof is preferably 5 or higher.

The admixed quantity of the carbon nanotubes in the present invention is preferably 0.1% by mass with respect to the mass of the composition as a whole, and 1% by mass or higher thereof is more preferred, but the admixed quantity can be adjusted according to the desired conductive properties of the fluororesin composition.

The carbon nanotubes may be used in a master batch in which they are mixed and kneaded with the resin in advance to enhance dispersion properties in the fluororesin. It is preferred that the same fluororesin as in the fluororesin composition ultimately manufactured be used to form the master batch.

The fluororesin composition of the present invention can be molded into the desired shape as a result of extrusion molding, roller molding, injection molding, or another method after the fluororesin is mixed with the carbon nanotubes in the desired ratio.

The present invention will be described hereinafter using working examples and comparative examples.

A quantity of carbon nanotubes was added to the fluorine-based surfactant shown in Table 1 to give the admixture ratio of solids shown in Table 1, and the product was dried at 110° C. after being thoroughly stirred.

The fluororesin and carbon nanotubes were fed in the weight ratio shown in Table 1 from two feeders into the hopper of a twin-screw extruder (KZW20-25G, manufactured by Technovel, Inc.). The twin-screw extruder was set to a cylinder temperature of 330° C. and a die temperature of 340° C., and after melt-extruding the fluororesin and the carbon nanotubes into a strand at a screw speed of 30 rpm, the product was cooled in a water bath, and pellets having a diameter of 1.5 mm and a length of 3 mm were manufactured using a pelletizer.

In Comparative Example 4, the dispersion FEP120J was dried, the surfactant was washed off with methanol, the product was extruded into a strand with the help of a single-screw extruder, and the extrudate was formed into pellets with a diameter of 1.5 mm and a length of 3 mm with the help of a pelletizer.

“Comparison” in the table indicates a comparative example.

Ten grams of pellets obtained as a result of kneading the above components in a twin-screw extruder were molded into a sheet with a thickness of 0.2 mm in a hot press at 350° C., and the surface resistance was measured using a high resistivity meter (Hiresta-IP, manufactured by Mitsubishi Chemical) and a low resistivity meter (Loresta-AP, manufactured by Mitsubishi Chemical). The evaluation results are shown in Table 1 in units of Ω/square.

After discharging 100 g of sample pellets using a static electricity discharger (SF-1000, manufactured by As One Corporation), the pellets were placed in a polyethylene bag, the mouth of the bag was closed with the bag expanded, the bag was shaken up and down vigorously ten times, and the electrostatic charge properties were determined in response to whether or not the pellets adhered to the walls of the bag by way of static electricity. Samples that did not adhere were designated “good,” and samples that adhered were designated “poor.”

In Table 1, PFA350J, PFA450J, PFA340J, and PFA420J are tetrafluoroethylene-fluoroalkyl vinyl ether copolymers (PFA) manufactured by Mitsui Du Pont Fluorochemical Inc. The terminal groups in PFA450J and PFA420J were stabilized.

FEP100J and FEP120J are tetrafluoroethylene-hexafluoropropylene copolymers (FEP) manufactured by Mitsui Du Pont Fluorochemical Inc. The terminal groups in FEP100J were stabilized.

ETFEC88AX was a tetrafluoroethylene-ethylene copolymer (ETFE) manufactured by Asahi Gas Inc.

Numerical values in the table indicate admixed weight ratios of solids.

The surfactants were as described below.

SA1 is potassium perfluoro-octane sulfonate which was used to treat carbon nanotubes in a methanol solution of 4% by mass.

SA2 is lithium perfluoro-octane sulfonate which was used to treat carbon nanotubes in a methanol solution of 4% by mass.

SA3 is lithium perfluorobutane sulfonate which was used to treat carbon nanotubes in an aqueous solution of 4% by mass.

Numerical values for the surfactants in the table indicate admixed weight ratios of solids.

CNT indicates carbon nanotubes; VGCF indicates vapor-grown carbon fibers with a diameter of 150 nm manufactured by Showa Denko; and CNT20 indicates carbon nanotubes with a diameter of 20 nm manufactured by Carbon Nanotech Research Institute Inc.

Numerical values indicate admixed weight ratios of solids.

In the fluororesin composition of the present invention, carbon nanotubes treated with a fluorine-based surfactant are used as a conductive filler, so a conductive fluororesin composition having excellent electrostatic charge properties can be provided, and the present invention can be utilized in the manufacture of electrical materials and electronic materials having excellent conductivity, electrostatic properties, and other electrical properties.

1. A fluororesin composition comprising a mixture of a fluororesin and carbon nanotubes whose surfaces have been treated with a fluorine-based surfactant.

2. The fluororesin composition according to claim 1, wherein the fluorine-based surfactant comprises at least one type selected from the group that includes fluoroalkyl sulfonates, fluoroalkyl carbonates, and salts thereof.

3. The fluororesin composition of claim 1, wherein terminal groups of the fluororesin are stabilized.

4. The fluororesin composition of claim 2, wherein terminal groups of the fluororesin are stabilized.

5. The fluororesin composition of claim 3, wherein the fluororesin with stabilized terminal groups comprises a substance selected from perfluoroalkoxyalkane polymers and perfluoroethylene propylene copolymers.

6. The fluororesin composition of claim 4, wherein the fluororesin with stabilized terminal groups comprises a substance selected from perfluoroalkoxyalkane polymers and perfluoroethylene propylene copolymers.
